(19) United States
(12) Patent Application Publication
(10) Pub. No.: US 2019/0084888 A1
(43) Pub. Date: Mar. 21, 2019

(54) EUTECTIC CERMETS

(71) Applicant: National Tsing Hua University, Hsinchu (TW)

(72) Inventor: Swe-Kai CHEN, Hsinchu (TW)

(21) Appl. No.: 15/962,079

(22) Filed: Apr. 25, 2018

(30) Foreign Application Priority Data
Sep. 21, 2017 (TW) 106132474

(51) Int. Cl. C04B 35/56; C04B 35/657

(52) U.S. Cl. CPC C04B 35/5626; C04B 35/5622; C04B 35/5611; C04B 35/657; C04B 2235/9607; C04B 2235/3847; C04B 2235/404; C04B 2235/6581; C04B 2235/80; C04B 2235/3843

(57) ABSTRACT

Eutectic cermet materials include at least two carbides and a refractory metal, wherein the carbide is selected from the group of TiC, VC, ZrC, HfC, WC, NbC and TaC, and the refractory metal is tungsten. The disclosed eutectic cermet material prepared is by smelting the carbide and the refractory metal together at a temperature lower than melting temperatures of the carbide and the refractory material. The melting temperature lowered by forming a eutectic composition is to prepare the eutectic cermet materials having a fine lamellar structure. The prepared eutectic cermet materials improve hardness and toughness at use.

### CROSS REFERENCE TO RELATED APPLICATION

This application claims the benefit of Taiwan Patent Application Serial No. 106132474, filed on Sep. 21, 2017, the subject matter of which is incorporated herein by reference.

### BACKGROUND OF THE INVENTION

### 1. Field of the Invention

The disclosure relates to eutectic cermet materials, and more particularly to eutectic cermets with a fine lamellar structure and are prepared by having at least two carbides and a refractory metal smelted with the carbides and the refractory metal forming eutectics having lower melting temperatures and good toughness.

### 2. Descriptions of the Related Art

Cemented carbide is a composite composed of WC and Co. In the early 1900s, Henri Moissan artificially synthesized tungsten carbide (WC). Tungsten carbide has a high hardness intending to replace diamond. However, tungsten carbide is brittle and porous, such that is it not suitable in engineering. In 1923, Schröter and Baumhauer found out that after sintered with cobalt or nickel, tungsten carbide can maintain the hardness of ceramics and has the toughness of metals. Thus, it is beneficial in tool industry. The material can be widely used in different units of cutting tools, mineral extractions and military weapons. About 60% of W material used is in producing cemented carbides. The demand was 10 tons in 1930 with the demand for the same jumping to 50,000 tons in 2008.

Cemented carbides are composed of a strengthening phase and a cemented phase. As described above, WC may function as the strengthening phase, and it has a high melting point, a high toughness as well as a good wear resistance. On the other hand, Co function as the cemented phase, and it has a high electrical and thermal conductivity but does not have a high enough melting point (for Co, 1492° C.) for even higher temperature uses. Having components that are high in toughness could render the composite not brittle. In recent studies, hard metals, such as WC and Co, are used as the base material with TiC, TaC and so forth functioning as the strengthening phase and Mo, Ni, Fe and so forth functioning as the cemented phase. These materials are hard metal and cermet composites. Traditional hard metals and cermet composites are mainly prepared by sintering, and the minute amount of the cemented phase is incorporated; however, the density of the composite is another problem for the cemented carbide prepared by the traditional sintering described above. The traditional preparation method is relatively complicated, along with the larger cost and the limited operating temperature of the composite.

Therefore, if the material can be prepared by smelting, the above density problem is gone. However, the smelting temperature is usually high for melting. Therefore, if at least two carbides and one refractory metal can be prepared according to different designed composition to achieve eutectic point by lowering the melting temperature, the prepared eutectic cermet material has eutectic properties, and the prepared eutectic cermet material can be with good hardness and good toughness at use.

### SUMMARY OF THE INVENTION

Disclosed is a kind of eutectic cermet materials. The composition of the eutectic cermet material may include at least two carbides and a refractory metal. The carbide is selected from the group of TiC (mp, melting point, is 3067° C.), VC (mp is 2830° C.), ZrC (mp is 3420° C.), HfC (mp is 3928° C.), WC (mp is 2870° C.), NbC (mp is 3600° C.) and TaC (mp is 3950° C.), and the refractory metal is tungsten (mp is 3410° C.). The prepared disclosed eutectic cermet materials are by heating and smelting the carbide and the refractory metal under a temperature lower than melting temperatures of the carbide and of the refractory metal.

In one embodiment, the eutectic cermet material includes tantalum, niobium, carbon and tungsten. Tantalum is 15˜25% of the composition, niobium is 14˜17% of the composition, carbon is 12˜20% of the composition, and tungsten is 45˜59% of the composition. (Compositions are in mass or weight %, the same for below.)

In another embodiment, the eutectic cermet material includes titanium, tantalum, carbon and tungsten. Titanium is 9˜15% of the composition, tantalum is 6˜11% of the composition, carbon is 15˜25% of the composition, and tungsten is 50˜70% of the composition.

In another embodiment, the eutectic cermet material includes titanium, tantalum, niobium, carbon and tungsten. Titanium is 7˜11% of the composition, tantalum is 4˜7% of the composition, niobium is 4˜7% of the composition, carbon is 17˜25% of the composition, and tungsten is 55˜68% of the composition.

In another embodiment, the eutectic cermet material includes titanium, tantalum, niobium, vanadium, carbon and tungsten. Titanium is 7˜11% of the composition, tantalum is 4˜7% of the composition, niobium is 4˜7% of the composition, vanadium is 2˜5% of the composition, carbon is 19˜25% of the composition, and tungsten is 47˜64% of the composition.

In another embodiment, the eutectic cermet material includes titanium, tantalum, niobium, vanadium, zirconium, hafnium, carbon and tungsten. And titanium is 3˜7% of the composition, tantalum is 3˜7% of the composition, niobium is 3˜7% of the composition, zirconium is 1˜3% of the composition, hafnium is 1˜4% of the composition, vanadium is 7˜12% of the composition, carbon is 21˜25% of the composition, and tungsten is 47˜61% of the composition.

### BRIEF DESCRIPTION OF THE DRAWINGS

FIG. 1 is a flow chart of the process for preparing the eutectic cermet material of the disclosure;

FIG. 2 is a schematic view of the XRD analysis of the eutectic cermet material according to the first embodiment of the disclosure;

FIG. 3 is a schematic view of the XRD analysis of the eutectic cermet material according to the second embodiment of the disclosure;

FIG. 4 is a schematic view of the XRD analysis of the eutectic cermet material according to the third embodiment of the disclosure;

FIG. 5 is a schematic view of the XRD analysis of the eutectic cermet material according to the fourth embodiment of the disclosure;

FIG. 6 is a schematic view of the XRD analysis of the eutectic cermet material according to the fifth embodiment of the disclosure;

FIG. 7 is a schematic view of the XRD analysis of the eutectic cermet material according to the sixth embodiment of the disclosure;

FIG. 8 is a schematic view of the XRD analysis of the eutectic cermet material according to the seventh embodiment of the disclosure;

FIG. 9 is schematic view of the hardness of the eutectic cermet material with a lamellar structure between room temperature and a high temperature according to the disclosure; and

FIG. 10 is schematic view of the loss ratio of the hardness of the eutectic cermet material with a lamellar structure under 1100° C. according to the disclosure.

### DETAILED DESCRIPTION OF THE PREFERRED EMBODIMENTS

The technical solutions, features and effects of the disclosure clearly described are in the description of preferred embodiments with reference to the drawings.

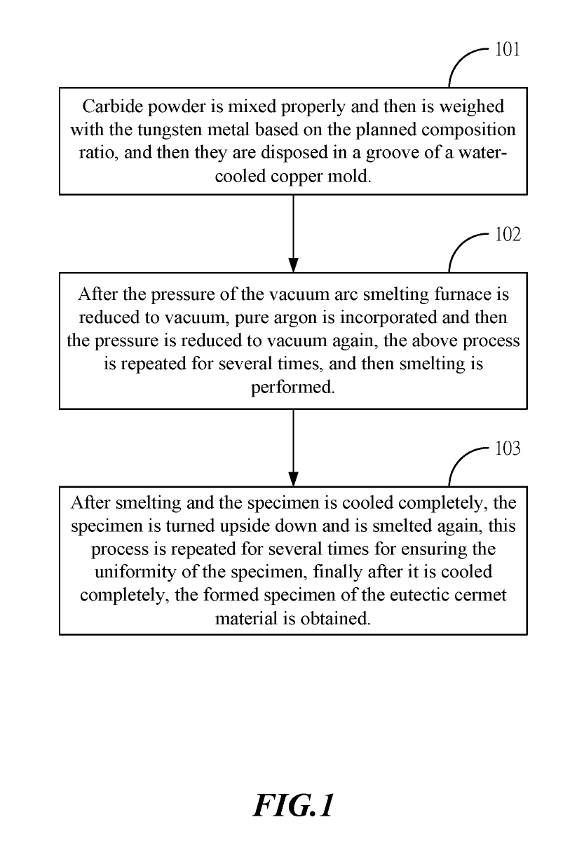

Referring to FIG. 1, the preparation for disclosed composite is as the following:

(1) According to the disclosure, the carbide powder (TiC, VC, ZrC, HfC, WC, NbC, TaC) is mixed properly and then is weighed with the tungsten metal based on the designed composition; both the carbide powder and the tungsten metal are disposed in a groove of a water-cooled copper mold of a vacuum arc smelting furnace (101);

(2) After the pressure of the vacuum arc smelting furnace is reduced to “vacuum” (2.4×10⁻² torr), pure argon (Ar) is incorporated until the pressure is elevated to about 8.0 torr, and then the pressure is reduced to “vacuum” again to 2.4×10⁻² torr. The process of incorporating Ar and then reducing the pressure refers to as “purge”. The above process is repeated for several times, and then argon is incorporated until the pressure is back to about 8.0 torr before the performance of smelting (102); and

(3) After the smelting and after the specimen is cooled, the specimen is turned upside down and is smelted again. This process is repeated for several times for ensuring the uniformity of the specimen; once after the specimen is cooled completely, and the pressure of the furnace is elevated to 1 atm, the formed specimen of the eutectic cermet material is obtained (103).

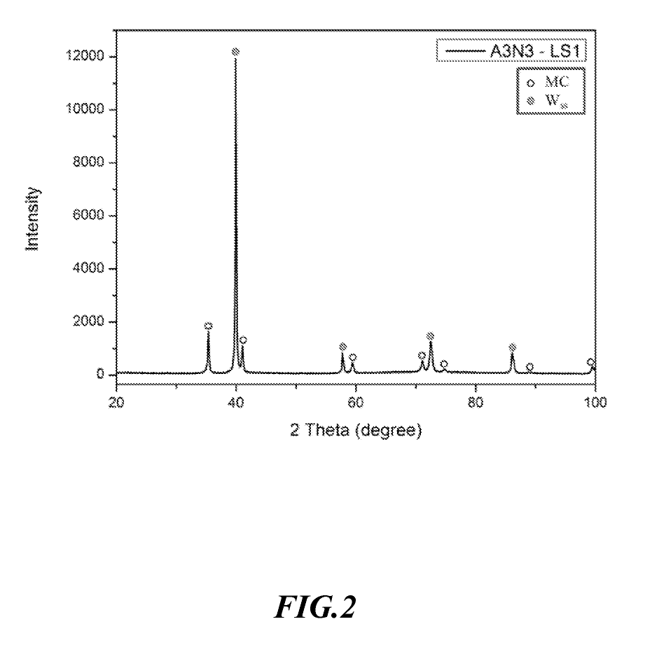

According to the disclosure, different carbides and tungsten metal mixed are in the designed composition to form eutectic. Accordingly, obtained are eutectic cermet materials with a fine lamellar structure. According to FIGS. 2-8, the microstructures show that they mainly include the eutectic structure of Wₛₛ, MC and M₂C, which have high melting temperatures that are higher than 2500° C. Wₛₛ is a solid solution of tungsten, and M is the transitional metal contained in the multivariate mixtures such as MC and M₂C).

According to the first example of the composition, the composition comprises tantalum (Ta), niobium (Nb), carbon (C) and tungsten (W). Tantalum is 15˜25%, niobium is 14˜17%, carbon is 12˜20%, and tungsten is 45˜59%.

According to the above example, a first embodiment and a second embodiment are disclosed, wherein the first embodiment is A3N3-LS1 (Ta_{18.37}Nb_{16.12}C_{18.22}W_{47.29}). According to FIG. 2, when the first embodiment is analyzed by XRD, it is realized that the specimen includes a solid solution of MC-type carbide with FCC structure and a solid solution of W with BCC structure. In the first embodiment, the lamellar eutectoid structure is precipitated in the dendrites (black phase). In other words, the structure is precipitated in the supersaturated carbide solid solution (Carbide→Carbide′+Wₛₛ).

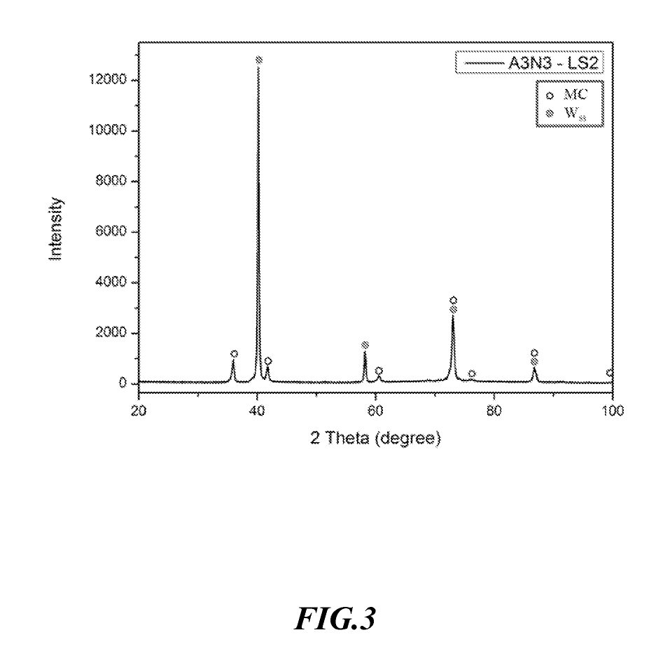

The second embodiment of the above example is A3N3-LS2 (Ta_{23.31}Nb_{15.07}C_{13.26}W_{48.36}). According to FIG. 3, when the second embodiment is analyzed by XRD, it is realized that the specimen includes a solid solution of MC-type carbide with FCC structure and a solid solution of W with BCC structure. Further, in the second embodiment a part of the lamellar structure is precipitated in the dendrites (black phase).

According to the second example of the composition, it includes titanium (Ti), tantalum (Ta), carbon (C) and tungsten (W). Titanium is 9˜15%, tantalum is 6˜11%, carbon is 15˜25%, and tungsten is 50˜70%.

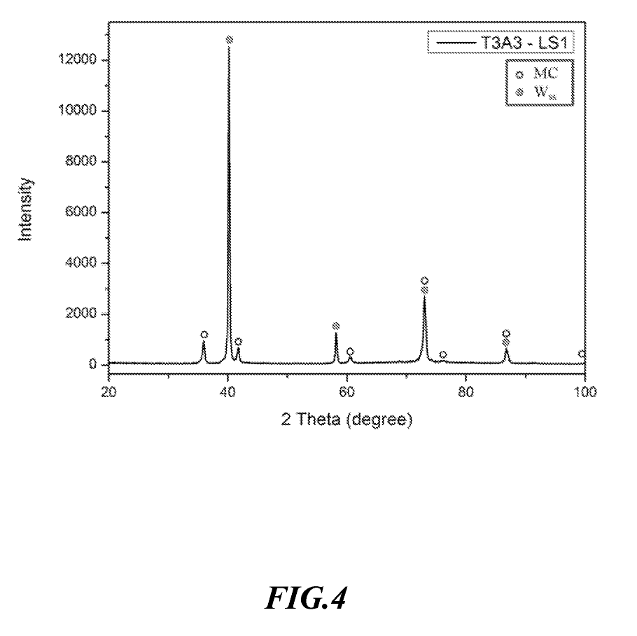

According to the above example, a third embodiment and a fourth embodiment are disclosed. According to FIG. 4, when the third embodiment, which is T3A3-LS1 (Ti_{11.26}Ta_{7.03}C_{17.59}W_{64.12}), is analyzed by XRD, the specimen includes a solid solution of MC-type carbide with FCC structure and a solid solution of W with BCC structure. In the third embodiment, the lamellar eutectoid structure is precipitated in the dendrites (black phase). In other words, the structure is precipitated in the supersaturated carbide solid solution (Carbide→Carbide′+Wₛₛ).

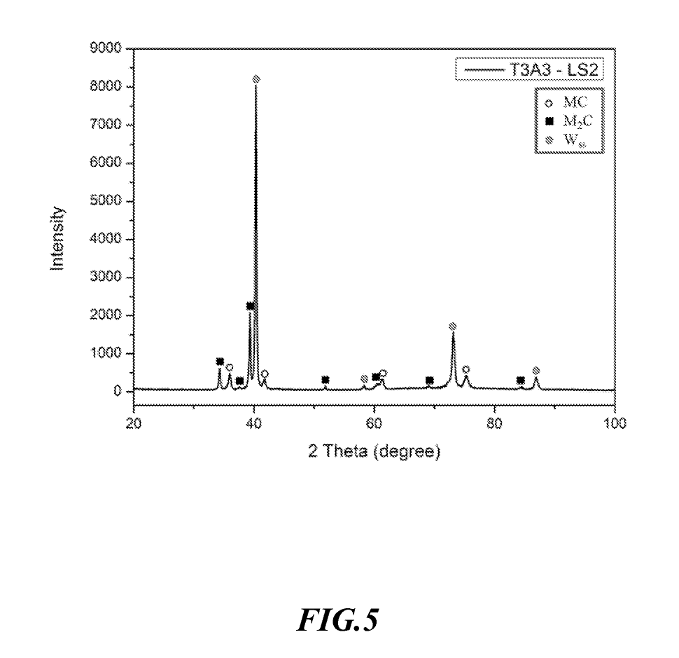

The fourth embodiment of the above example is T3A3-LS2 (Ti_{10.85}Ta_{8.05}C_{21.96}W_{59.14}). According to FIG. 5, when the fourth embodiment is analyzed by XRD, the specimen includes a solid solution of MC-type carbide with FCC structure, a solid solution of M₂C-type carbide with HCP structure and a solid solution of W with BCC structure. Also, in the fourth embodiment the lamellar eutectoid structure is precipitated in the dendrites (black phase). In other words, the structure is precipitated in the supersaturated carbide solid solution (Carbide→Carbide′+Wₛₛ).

According to the third example of the composition, the composition may include titanium (Ti), tantalum (Ta), niobium (Nb), carbon (C) and tungsten (W). And titanium is 7˜11%, tantalum is 4˜7%, niobium is 4˜7%, carbon is 17˜25%, and tungsten is 55˜68%.

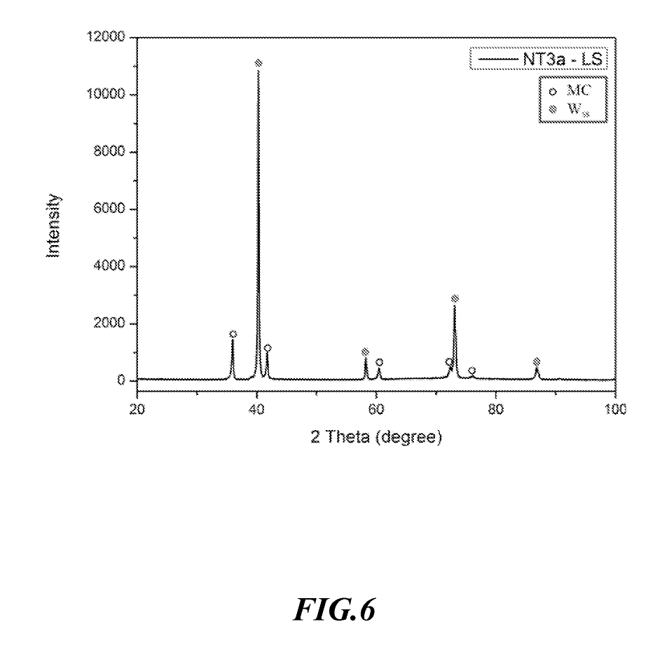

According to the above example, a fifth embodiment, which is NT3a-LS (Ti_{9.61}Ta_{5.72}Nb_{5.63}C_{19.69}W_{59.35}), is disclosed. According to FIG. 6, when the fifth embodiment is analyzed by XRD, the specimen includes a solid solution of MC-type carbide with FCC structure and a solid solution of W with BCC structure, and the lamellar eutectoid structure in the fifth embodiment is precipitated in the dendrites (black phase). In other words, the structure is precipitated in the supersaturated carbide solid solution (Carbide→Carbide′+Wₛₛ).

According to the fourth example of the composition, it includes titanium (Ti), tantalum (Ta), niobium (Nb), vanadium (V), carbon (C) and tungsten (W). Titanium is 7˜11%, tantalum is 4˜7%, niobium is 4˜7%, vanadium is 2˜5%, carbon is 19˜25%, and tungsten is 47˜64%.

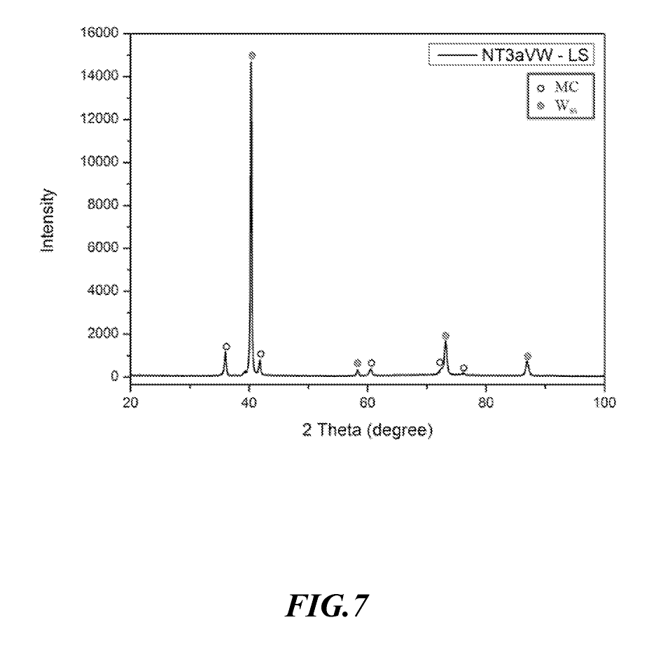

According to the above example, a sixth embodiment, which is NT3aVW-LS (Ti_{8.58}Ta_{5.83}Nb_{5.29}V_{3.06}C_{21.99}W_{55.25}), is disclosed. According to FIG. 7, when the sixth embodiment is analyzed by XRD, the specimen includes a solid solution of MC-type carbide with FCC structure and a solid solution of W with BCC structure, and the lamellar eutectoid structure in the sixth embodiment is precipitated in the dendrites (black phase and black MC phase of the primary crystal). In short, the structure is precipitated in the supersaturated carbide solid solution (Carbide→Carbide′+Wₛₛ).

According to the fifth example of the composition, it includes titanium (Ti), tantalum (Ta), niobium (Nb), vanadium (V), zirconium (Zr), hafnium (Hf), carbon (C) and tungsten (W). And titanium is 3˜7%, tantalum is 3˜7%, niobium is 3˜7%, zirconium is 1˜3%, hafnium is 1˜4%, vanadium is 7˜12%, carbon is 21˜25%, and tungsten is 47˜61%.

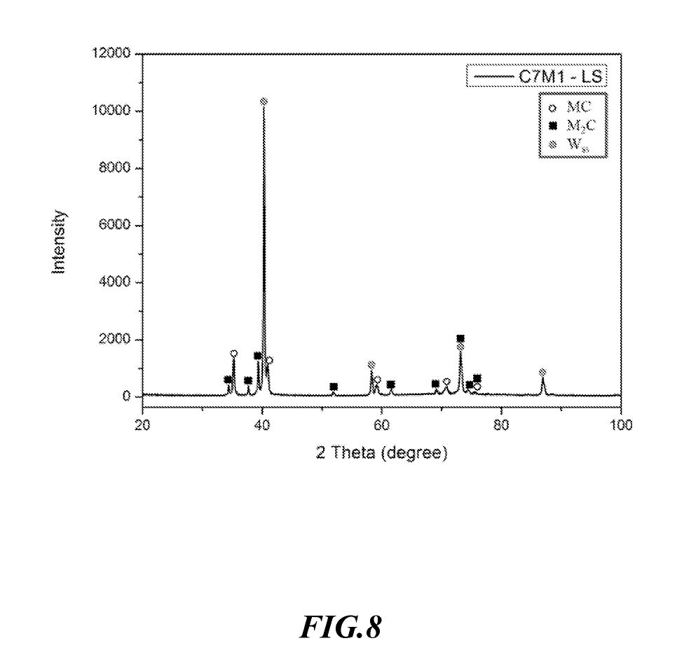

According to the above example, a seventh embodiment, which is C7M1-LS (Ti_{4.69}Ta_{4.84}Nb_{4.53}Zr_{1.94}Hf_{2.73}V_{9.27}C₂₃W₄₉), is disclosed. According to FIG. 8, when the seventh embodiment is analyzed by XRD, the specimen includes a solid solution of MC-type carbide with FCC structure, a solid solution of M₂C-type carbide with HCP structure and a solid solution of W with BCC structure. And in the seventh embodiment, sparse black stripe MC phase can be found as well as part of the lamellar structure can be found around the gray M₂C phase.

Table 1 compares the hardness and the fracture toughness of the above embodiments. The hardness of the above specimens with lamellar structure is about 1000 HV, and the specimen having the highest hardness is T3A3-LS2. In the above specimens with lamellar structure, the hardness is proportional to the toughness, which means the specimen having a higher hardness is associated with a higher toughness. Thus, a specimen with lamellar structure has both high hardness and high toughness, which indicates that the specimen having the lamellar structure can efficiently improve the hardness as well as the toughness at the same time.

TABLE 1
The hardness and fracture toughness
of the lamellar structure materials

| | Hardness | Fracture Toughness K_{IC} |
|---|---|---|
| Specimen | (HV₃₀) | (MPa m^{1/2}) |
| A3N3 - LS1 | 936 ± 14 | 11.1 ± 0.7 |
| A3N3 - LS2 | 754 ± 21 | 9.9 ± 0.8 |
| T3A3 - LS1 | 1055 ± 8 | 16.2 ± 4.9 |
| T3A3 - LS2 | 1199 ± 20 | 15.0 ± 1.5 |
| NT3a - LS | 1025 ± 5 | 11.4 ± 0.8 |
| NT3aVW - LS | 1071 ± 12 | 15.0 ± 3.8 |
| C7M1 - LS | 949 ± 16 | 14.2 ± 1.2 |

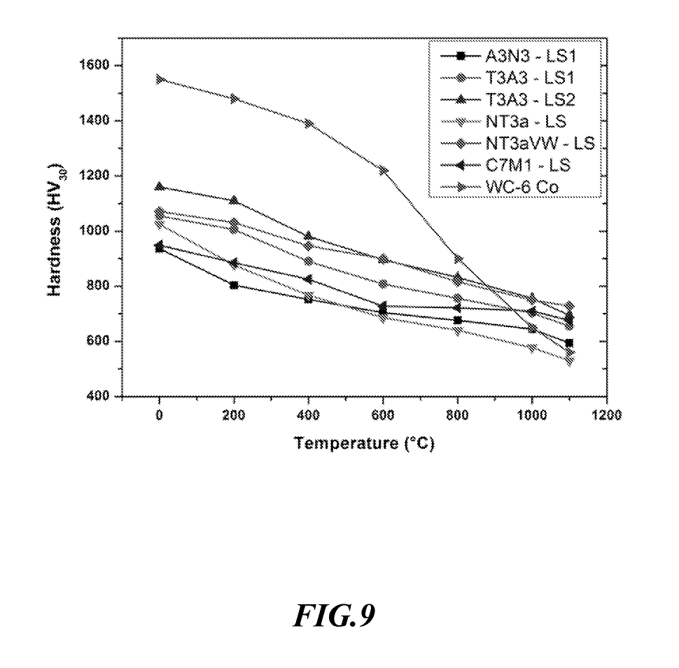

The above embodiments and commercial cemented carbide WC6-Co (94 wt. % WC-6 wt. % Co, prepared by sintering) are compared at high temperatures. As shown in FIG. 9, the specimens with the lamellar structure do not show drastic loss of hardness, which means the composites have not reached their temperature limits yet. The reason is that the specimens of the disclosure include a great amount of refractory metal, such as W, Nb, Ta and so forth.

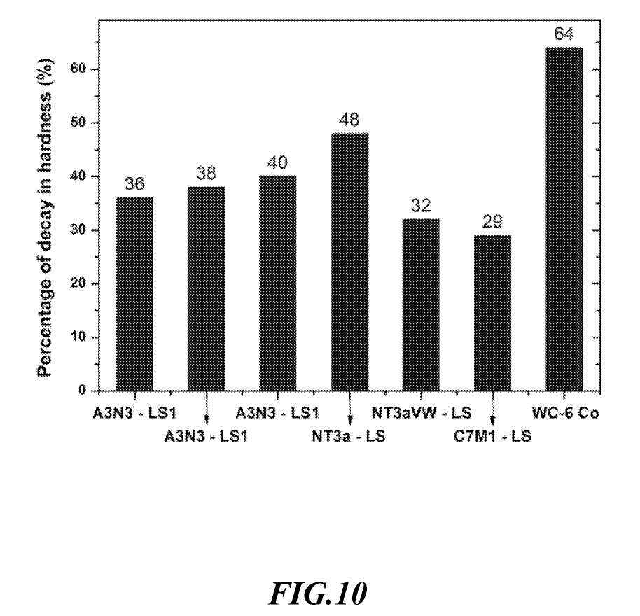

Further, as shown in FIG. 10, as compared to room temperature, the hardness of the specimen at 1100° C. is lowered by merely about 29˜48%. According to the embodiments of the disclosure, the specimen with the lowest hardness decrease (29%) at 1100° C. is C7M1-LS, which may just render its application suitable at high temperatures.

According to the disclosure, as compared to traditional technologies, the eutectic cermet material of the disclosure has the following advantages:

1. According to the disclosure, at least two carbides and a refractory metal mixed are in different designed composition to form eutectic structure; eutectic cermet material with a lamellar structure is prepared. The prepared eutectic cermet material has the eutectic property, and thus improves both the hardness and the toughness of the prepared eutectic cermet material at high temperatures.

2. According to the disclosure, the components are all refractory materials, such that the hardness under the high temperatures is good; since the composites of the disclosure are prepared by smelting, and the eutectic microstructure is well designed, the problem of deteriorating mechanical properties in connection with non-continuous phase grain growth, Ostwald ripening, under the high temperatures can be avoided.

3. According to the disclosure, since the eutectic cermet material can be prepared by lowering the melting temperature, and the prepared products have better hardness and toughness; also, the hardness stability under the high temperatures improves. Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. Eutectic cermet materials, wherein the eutectic cermet material comprises at least two carbides and a refractory metal, wherein the carbide is selected from the group of TiC, VC, ZrC, HfC, WC, NbC and TaC, the refractory metal is tungsten, wherein the eutectic cermet material is prepared by melting the carbide and the refractory metal together at a temperature lower than melting temperatures of both the carbide and the refractory metal.

2. The eutectic cermet materials according to claim 1, wherein the eutectic cermet material comprises tantalum, niobium, carbon and tungsten, wherein tantalum is 15˜25%, niobium is 14˜17%, carbon is 12˜20%, and tungsten is 45˜59%.

3. The eutectic cermet materials according to claim 1, wherein the eutectic cermet material comprises titanium, tantalum, carbon and tungsten, wherein titanium is 9˜15%, tantalum is 6˜11%, carbon is 15˜25%, and tungsten is 50˜70%.

4. The eutectic cermet materials according to claim 1, wherein the eutectic cermet material comprises titanium, tantalum, niobium, carbon and tungsten, wherein titanium is 7˜11%, tantalum is 4˜7%, niobium is 4˜7%, carbon is 17˜25% and tungsten is 55˜68%.

5. The eutectic cermet materials according to claim 1, wherein the eutectic cermet material comprises titanium, tantalum, niobium, vanadium, carbon and tungsten, wherein titanium is 7˜11%, tantalum is 4˜7%, niobium is 4˜7%, vanadium is 2˜5%, carbon is 19˜25%, and tungsten is 47˜64%.

6. The eutectic cermet materials according to claim 1, wherein the eutectic cermet material comprises titanium, tantalum, niobium, vanadium, zirconium, hafnium, carbon and tungsten, wherein titanium is 3˜7%, tantalum is 3˜7%, niobium is 3˜7%, f zirconium is 1˜3%, hafnium is 1˜4%, vanadium is 7˜12%, carbon is 21˜25%, and tungsten is 47˜61%.
